(19) United States
(12) Patent Application Publication
(10) Pub. No.: US 2017/0355100 A1
(43) Pub. Date: Dec. 14, 2017

(54) METHOD FOR MANUFACTURING PIECES BY THE TECHNIQUE OF ADDITIVE MANUFACTURING BY PASTY PROCESS AND MANUFACTURING MACHINE FOR IMPLEMENTING THE METHOD

(71) Applicants: UNIVERSITE DE LIMOGES, Limoges cedex (FR); CENTRE NATIONAL DE LA RECHERCHE SCIENTIFIQUE, Paris cedex 16 (FR); 3DCERAM, Limoges (FR)

(72) Inventors: Vincent PATELOUP, Chateauneuf la foret (FR); Victor CHARTIER, Limoges (FR); Christophe CHAPUT, Le Palais sur Vienne (FR)

(21) Appl. No.: 15/622,410

(22) Filed: Jun. 14, 2017

(30) Foreign Application Priority Data
Jun. 14, 2016 (FR) 1655464

(51) Int. Cl. B28B 1/00; B33Y 30/00; B33Y 10/00

(52) U.S. Cl. CPC B28B 1/001; B33Y 10/00; B33Y 30/00

(57) ABSTRACT

Disclosed is a method for manufacturing a green piece made of ceramic material by the technique of additive manufacturing according to which layers of a photocurable paste are successively allowed to cure by irradiation according to a pattern defined for each layer, the first layer being formed on a working surface on a working tray, each layer, before curing, being spread by scraping a paste mass provided on the working tray, which is lowered upon each formation of a layer. According to the disclosure, when spreading at least one of the photocurable paste layers, at least one scraping blade in working position, in addition to its scraping motion or so-called pass motion, is allowed to go back and forth in its plane, according to a so-called vibration motion.

The present invention relates to a method for manufacturing pieces by additive manufacturing and to a manufacturing machine for implementing the method.

These pieces are especially green pieces made of ceramic material which are intended to be subjected to cleaning, debinding and sintering operations so as to obtain finished ceramic pieces.

### BACKGROUND OF THE INVENTION

The technique of additive manufacturing, also called stereolithography, generally comprises the following steps, for obtaining such green pieces:
building, by computer-aided design, a computer model of the piece to be manufactured, the size of such a model being larger than that of the piece to be manufactured so as to anticipate shrinking of the ceramic during the manufacturing of the piece; and
manufacturing the piece by the technique of additive manufacturing, according to which technique:
   a first layer of a photocurable composition is formed on a rigid support or on a piece being manufactured, such first layer comprising generally at least a ceramic material, at least a dispersant, at least a photocurable monomer and/or oligomer, at least a photoinitiator and at least a plasticizer;
   the first layer of the photocurable composition is allowed to cure, by irradiation according to a pattern defined from the model for said layer, forming a first stage;
   a second layer of the photocurable composition is formed on the first stage;
   the second layer of the photocurable composition is allowed to cure, by irradiation according to a pattern defined for said layer, forming a second stage, this irradiation being made by laser scanning of the free surface of the spread photocurable composition or by a diode projection system;
   optionally, the above steps are repeated so as to obtain the piece in green state.

The present invention relates to additive manufacturing methods in which the photocurable composition takes the form of a paste the composition of which is indicated above and the viscosity of which may vary especially from 1 Pa·s to infinity for a zero shear rate.

In a manufacturing by paste process, the rigid support is a working tray supporting the different layers of the piece being manufactured as well as the paste and each of the layers is formed by lowering the working tray and spreading a paste with a predefined thickness. A supply of paste is stored in tanks which are automatically emptied of a predefined amount of paste at each layer by means of a piston. This creates a paste bead to be spread on the upper layer of the piece being manufactured which has been lowered beforehand by the working tray.

Each layer is spread by scraping by means of a scraping blade which sweeps the working surface of the working tray, for example by advancing according to a rectilinear horizontal direction.

Under these conditions, irregular and inhomogeneous layers in terms of thickness are formed, such a thickness ranging from few tens of microns to several millimeters. Consequently, the piece will not have a good external appearance and unwanted internal stresses may appear therein, so that the manufactured pieces must be discarded.

Furthermore, important scraping efforts can be generated, during the step of building by layers, so that pieces break during their building.

U.S. Pat. No. 5,902,537 discloses a scraping device using rollers, allowing to spread the paste so as to homogenize the thickness of the layers. This device is not adapted to viscous compositions and proves to be impractical in use, because a lot of trouble for cleaning it up after use.

The present invention is intended to address those inconveniences, namely to improve the homogeneity of each spread paste layer, to avoid too important scraping efforts which may destroy pieces being built, and to facilitate the cleaning up of the scraping device.

For that purpose, it is provided, according to the invention, that the uniform spreading of the paste is achieved by the combination of the horizontal sweeping motion or pass motion of the blade, which ensures the scraping in a conventional manner, with an oscillating motion or vibration motion horizontal and perpendicular to the pass motion and in the building plane of the layer. The oscillations allow to give to at least the upper part of the layer to be spread a shear speed sufficiently large to fluidize the paste to be spread which has a shear-thinning behavior and thus to significantly reduce the scraping efforts.

### BRIEF SUMMARY OF THE INVENTION

Consequently, the subject matter of the present invention is a method for manufacturing a green piece made of ceramic material by the technique of additive manufacturing according to which layers of a photocurable paste are successively allowed to cure by irradiation according to a pattern defined for each layer, the first layer being formed on a working surface on a working tray, each layer, before curing according to a defined pattern, being spread by scraping a paste mass provided on said working tray which is lowered upon each formation of a layer, characterized in that, when spreading at least one of the photocurable paste layers, at least one scraping blade in working position, in addition to its scraping motion or so-called pass motion, is allowed to go back and forth in its plane, according to a so-called vibration motion, horizontal and perpendicular to the pass motion.

According to a first embodiment, the pass motion can result from having the one or more scraping blades progressing according to a rectilinear horizontal displacement from an edge of the working surface along which was brought the paste mass to be spread in the form of a bead, to its opposite edge, in order to spread the said bead of paste on the working surface. The pass motion is here perpendicular to the plane of the at least one blade.

According to a second embodiment, the pass motion can result from sweeping the one or more scraping blades according to a pivoting movement about an axis perpendicular to the working surface and positioned in a point of the working surface.

The vibration frequency can be advantageously determined according to rheological characteristics of the paste, the frequency being chosen to reduce the viscosity of the paste.

At least one scraping blade can be given a vibration movement by a mechanical or piezoelectric or electromagnetic driver system, the vibration frequencies being advantageously 1-200 Hz, 500-5000 Hz or 100-1000 Hz respectively, depending on whether the system is mechanical, piezoelectric or electromagnetic.

In particular, the vibration movement can be done by a mechanical driver system at a frequency of 1 to 100 Hz, especially of 35 to 55 Hz.

The vibration movement can be done on a stroke of 0.1 to 5 mm.

The one or more scraping blades can be maintained in tension between two springs to modify the natural frequency of the vibration movement, advantageously allowing the one or more blades to vibrate at the resonance frequency of the oscillating system comprising the one or more blades, the one or more associated blade holders and said springs.

The depth of penetration in paste of the scraping edge of one or each blade can be adjusted.

Only one scraping blade can be used, or at least two contiguous or spaced scraping blades parallel to each other can be used, the scraping edges of said blades being arranged at staggered heights, the scraping edge of the leading blade being the highest relative to the working surface, the vibration frequencies of said blades being possibly different.

According to a particular embodiment of the implementation of the method for manufacturing pieces according to the invention:
(a) a paste mass to be spread is provided on a working tray, then a first layer of said paste is spread by scraping using the one or more scraping blades, along a horizontal direction, or pass direction;
(b) the desired area of said first layer is cured by irradiation according to a previously defined pattern for said layer, forming a first cured layer in the desired area;
(c) a second paste layer is spread over the whole said first cured layer in the desired area, by scraping using the one or more scraping blades, along the pass direction;
(d) the desired area of the second paste layer is cured by irradiation according to a previously defined pattern for said layer, forming on the first layer a second cured layer in the desired area;
(e) the succession of steps of spreading a paste layer and of curing the desired areas of each layer is repeated as many times as required until obtaining the piece,
   where, when spreading the at least one of the paste layers, the one or more scraping blades in working position are allowed to go back and forth according to a vibration movement in a horizontal direction perpendicular to the pass direction.

The invention relates also to a machine for manufacturing green pieces made of ceramic material by the technique of additive manufacturing according to which layers of a photocurable paste are successively allowed to cure by irradiation according to a pattern defined for each layer, said machine comprising:
a frame surrounding a horizontal working tray comprising a working surface;
a portal frame equipped with at least one scraping blade, the portal frame being adapted to move on the frame over the working tray so that the free edge of the one or more scraping blades is adapted to spread by scraping paste layers over the working surface, said layers being vertically superimposed;
irradiation means facing the working tray to irradiate each layer once spread to cure it in the previously defined pattern before spreading the following layer,

which is in turn cured in the defined pattern, characterized in that the one or more blades is slidably mounted to go back and forth in their plane so as to ensure a back and forth movement, designated vibration movement, during at least a pass of the portal frame along the pass direction over the working surface.

This machine is especially intended to the implementation of the method as above defined.

The one or more blades are advantageously vertically movable.

The machine can comprise one or more blade holders, each one holding at least one blade and being vertically movable on the portal frame, the one or more blade holders being possibly maintained and displaced in a top position, lifted up above the working tray. Especially, one or more blades can be arranged on a blade holder or one blade holder by blade can be provided.

The or each blade holder can comprise at least one horizontal rail and the or each blade can comprise at least one pad for its guiding on the at least one rail.

The machine can comprise advantageously a device for driving the vibration movement of the one or more blades by a mechanical or piezoelectric or electromagnetic system.

According to a first embodiment, the driving device is an eccentric excitation mechanism and comprises an assembly constituted by a motor and a disc driven by the motor either directly or via a belt along an offset rotation axis, the offset rotation axis being in the pass direction.

According to a second embodiment, the driving device is a mechanism comprising an assembly constituted by a motor, a crank and a connecting rod connected at one end to the front face of the one or more blades and at the other end to the crank driven by the motor on an offset rotation axis, said offset rotation axis being in the pass direction, said connecting rod being displaced in the plane of the one or more blades.

According to a third embodiment, the driving device is a mechanism comprising an assembly constituted by a motor and a cam being in contact with a blade, said cam, driven by the motor on an offset rotation axis, rolling upon its rotation by sliding against the one or more blades and causing it or them to go back and forth.

In the three above embodiments, the motor can be controlled by the machine controller, being advantageously voltage controlled to ensure the searched frequency for the vibration movement. By way of example, a motor speed of 3000 rev/min (rpm) producing a frequency of 50 Hz can be mentioned.

According to a fourth embodiment, the excitation mechanism is a piezoelectric driver system.

According to a fifth embodiment, the excitation mechanism is an electromagnetic driver system.

The machine can also advantageously comprise elastic return means of the one or more blades along a direction perpendicular to the pass direction.

The machine according to the invention can comprise only one blade or at least two contiguous or spaced blades, which are parallel to each other, with a common driving device of the vibration movement or a driving device associated to each blade.

The one or more blade holders can comprise wheels allowing it or them to roll over the frame.

The irradiation means can be constituted, only by way of example, by a laser, laser diodes, UV illumination and the like.

### BRIEF DESCRIPTION OF THE DRAWINGS

To better illustrate the subject-matter of the present invention, several embodiments will be described hereinafter, with reference to the accompanying drawings, by way of example only.

FIGS. 1 to 6 show perspective schematic views illustrating the different positions taken, during a spreading cycle by scraping a paste layer, by a scraping device according to a first embodiment of a manufacturing machine of sintered bodies by the technique of additive manufacturing layer by layer; the mechanism of translation displacement in its plane of the scraping blade has been omitted on these figures not to overload them;

FIG. 7 shows, on a larger scale and under the same angle as FIGS. 1 to 6, a perspective view of said mechanism of translation displacement of the scraping blade, said mechanism being mounted on the latter and on the blade holder;

FIG. 8 shows, on a further larger scale, a front view corresponding to FIG. 7;

FIGS. 9 and 10 show sectional views along IX-IX and X-X respectively of FIG. 8, FIG. 10 being on a larger scale;

FIG. 11 shows a side view according to arrow XI of FIG. 8;

FIG. 12 shows a top view corresponding to FIG. 8;

FIG. 13 shows a view similar to FIG. 1 but on which appears the mechanism of transverse displacement of the scraping blade on its blade holder according to a second embodiment;

FIG. 14 shows a perspective view of a triple scraping blade;

FIG. 15 shows a front view corresponding to FIG. 14;

FIG. 16 shows a sectional view according to XVI-XVI of FIG. 15;

FIG. 17 shows a top view corresponding to FIG. 15;

FIG. 18 shows a view similar to FIG. 2 illustrating an assembly comprising two scraping blades to each of which are associated a means for driving the vibration movement and elastic return means.

### DETAILED DESCRIPTION OF THE INVENTION

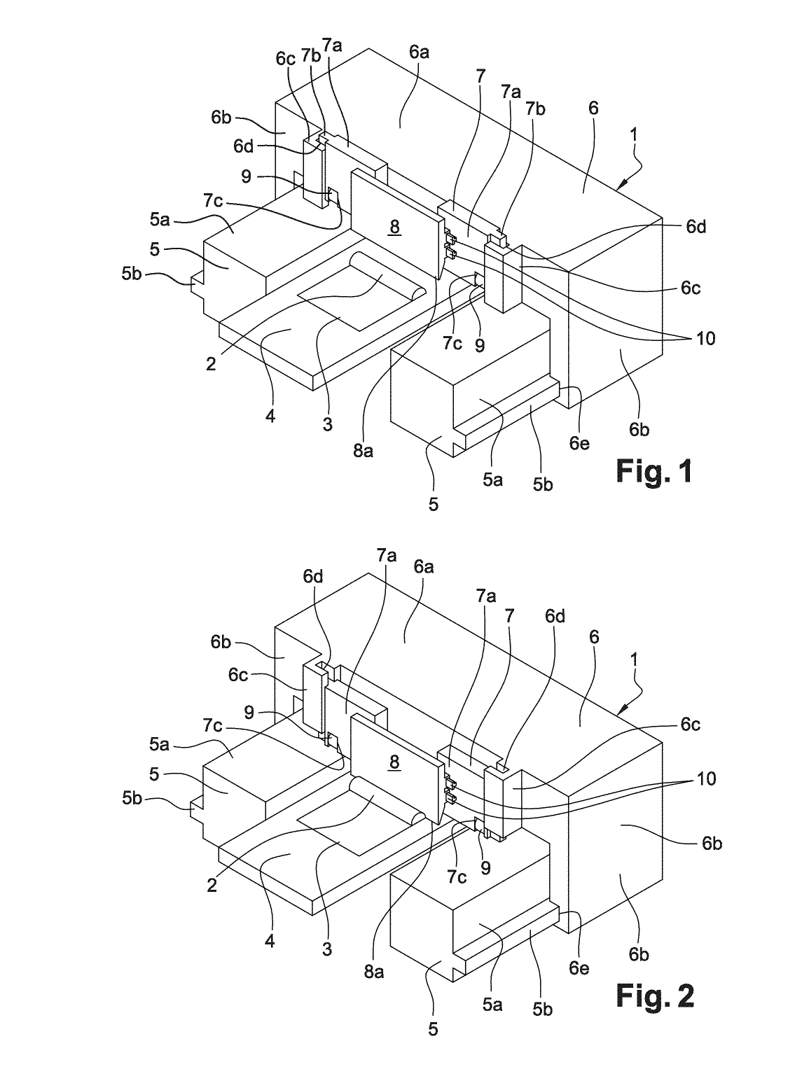

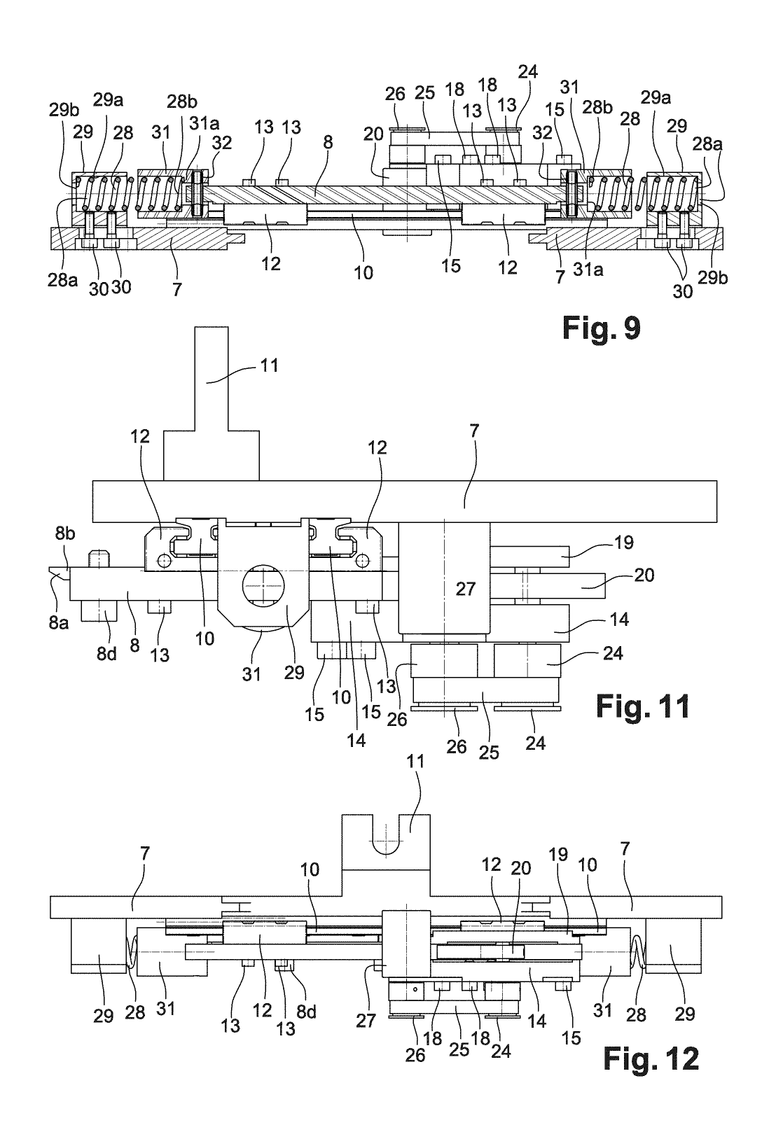

In reference to FIGS. 1 and 7 to 12, is shown a scraping device 1 of a paste layer 2 on a working surface 3 of a horizontal working tray 4 of a manufacturing machine of green bodies made of ceramic material by the technique of additive manufacturing.

The scraping device 1, slidably mounted on the frame 5 of the machine, comprises, from the back to the front if we look at FIG. 1, a portal frame 6, a blade holder 7 vertically slidably mounted at the front of the portal frame 6, and a scraping blade 8 having a horizontal scraping edge, mounted with the possibility of horizontal transverse back and forth displacement relative to the blade holder 7.

The frame 5 comprises two elongated blocks 5a located on either side of the working tray 4, each of these blocks 5a comprising a rib 5b which extends horizontally over its entire outer lateral face and the function of which is indicated below.

The portal frame 6 consists in a block comprising an upper part 6a in the form of rectangular parallelepiped extending by two lower lateral parts 6b.

The front face of the upper part 6a comprises, in each of its junction areas with each of the lateral parts 6b, a protrusion 6c of U-shape section, a wing of which is contiguous to the front face of the part 6a, the grooves 6d of these U-shape sections being arranged opposite to each other. The function of these grooves 6d is indicated below.

In the vicinity of its base, each lateral part 6d comprises, inwardly facing, a groove 6e into which the block 5a associated to the frame 5 is adapted to slide by its corresponding rib 5b.

The blade holder 7 consists in a U-shape plate the side parts of which bear the reference numeral 7a and are arranged parallel to the front face of the block 6a of the portal frame 6, a rib 7b being carried by the outer edge of the blade holder 7 allowing the sliding of said rib 76 in the groove 6d associated to the portal frame 6. The blade holder 7 could just as well be a complete plate.

On FIG. 1, it can be seen also that a recess 7c is provided in the base of each plate 7a of the blade holder 7, each recess acting as a housing for a cylindrical wheel 9 adapted to rotate about a horizontal axis. These wheels 9 are arranged at such a height that they will roll on the upper part of the respective blocks 5a of the frame 5 when the blade holder 7 is lowered. They allow to maintain the blade holder 7 at a correct height relative to the frame 5. However, it can be noted that they are optional.

The scraping blade 8 comprises a chamfered lower edge 8a.

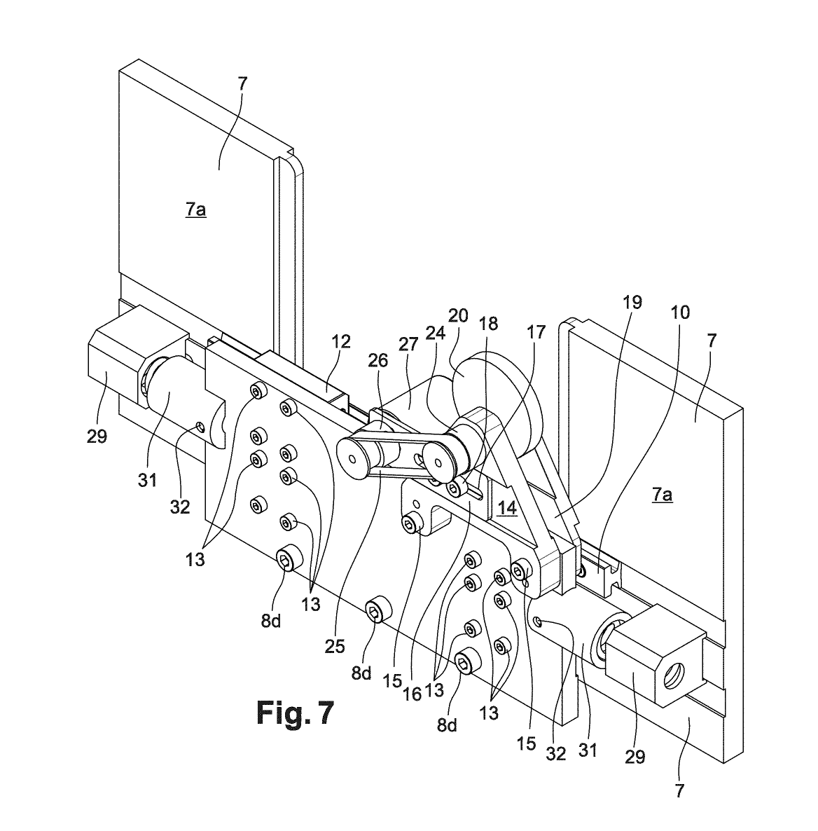

On FIG. 1, it can also be seen the track guides or rails 10 which are integrally formed with the blade holder 7 and which will be described with reference with FIG. 7.

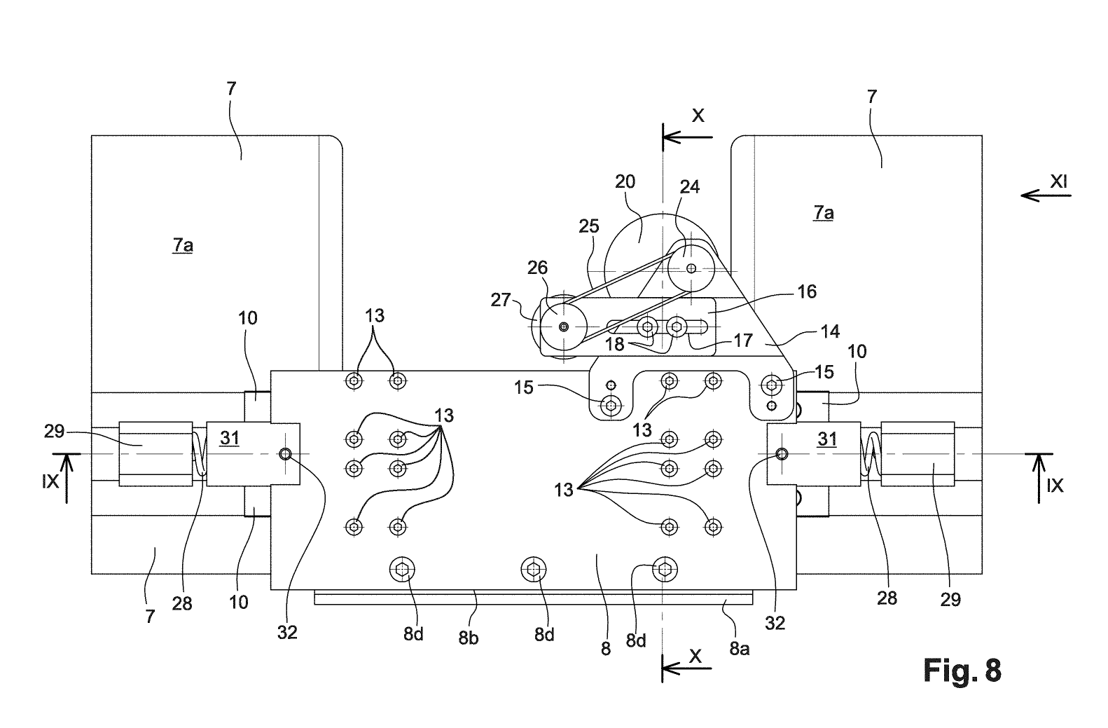

Now in reference to FIGS. 8, 10 and 11, it can be seen that the chamfered cutting edge 8a of the cutting blade 8 is part of a lower thin strip 8b, which is applied against the inner face of the blade 8 having a corresponding inwardly recess 8c and which is attached to said blade 8 by screws 8d.

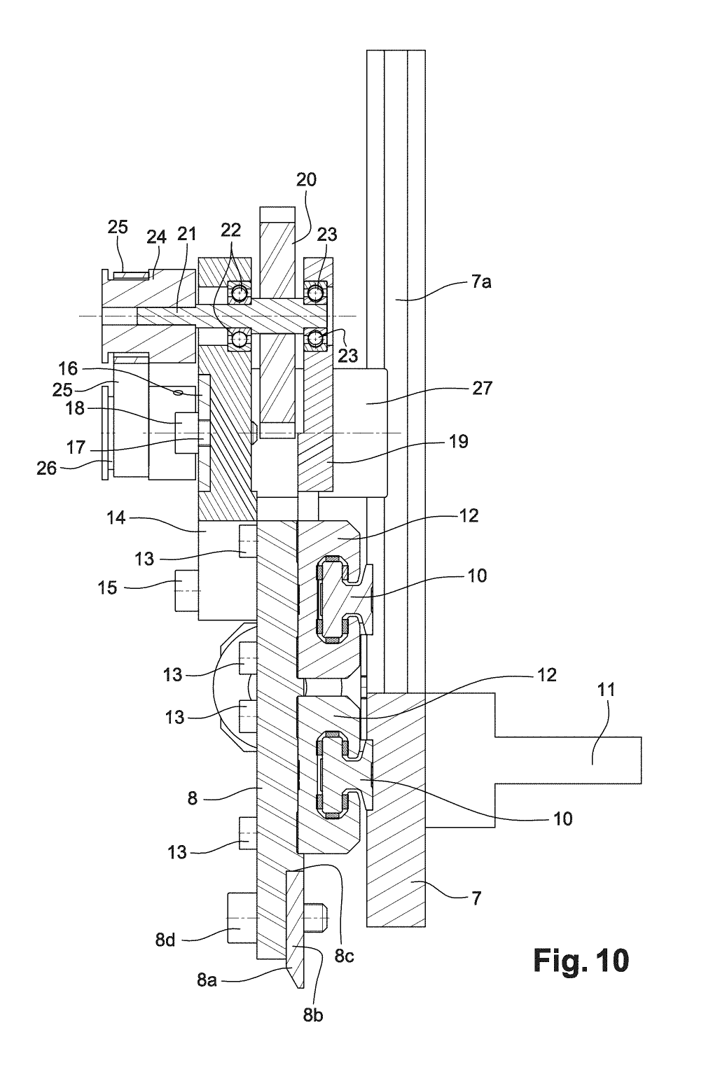

On FIGS. 10, 11 and 12, is also schematically shown the fastening system 11 to a motorization which is associated with the blade holder 7 and the actuating of which allows to move up and down the blade holder 7 under the conditions which will be described below.

Now in reference to FIGS. 7 to 11, it can be seen that two horizontal guiding rails 10 are integrally formed with the blade holder 7, on its front face and in its lower part.

Four pads 12 are made integral with the back face of the scraping blade 8 by screws 13, in positions allowing them to slide in respective rails 10 during the vibration movement of the scraping blade 8 which will be described below.

The mechanism of translation displacement of the blade 8 on its blade holder 7 will now be described.

A first support 14 of a triangular shape is applied against the front face of the blade 8 to the upper part of it, on a side (the right side if we look at FIGS. 7 and 8), and attached to said blade 8 by its base using two screws 15, the upper tip part of said support projecting itself above the blade 8.

Against the outer face of the support 14, is applied and attached an elongated plate 16 which protrudes from a side of the support 14 (on the left if we look at FIGS. 7 and 8). In this plate 16, is provided an oblong elongated hole 17, of horizontal axis, crossed perpendicularly by two adjusting screws 18, the function of which is indicated below.

A second support 19, having the same shape as the first support 14, is applied against the back face of the blade 8, so as to face said first support 14.

An eccentric wheel 20 is mounted between the upper tip parts of the two supports 14 and 19, above the scraping blade 8, the offset axis 21 of said wheel 20 rotating in bearings 22 and 23 respectively.

The axis 21 protrudes from the front of the plate 14 and receives a toothed pulley 24 within it, toothed pulley 24 on which is passed a toothed belt 25, which passes on a toothed pulley 26 associated with a motor 27.

Furthermore, in reference to FIGS. 7, 8 and 9, it can be seen that on each side of the blade 8 a coil spring 28 is arranged.

Each coil spring 28 is inserted, by its end area 28a opposite to the blade 8, in a cylindrical bore 29a of a cage 29 mounted by screws 30 on the blade holder 7, the end of the spring 28 abutting against the bottom 29b of the bore 29a.

The end area 28b close to the blade 8 abuts against the bottom 31a of a cylindrical bore 31b of a cylindrical cage 31 the end area of which opposite to the cage 29 covers the corresponding end area of the blade 8 so as to be attached to it by a screw 32.

For starting the excitation for the vibration movement of the blade 8, the motor 27 is actuated which drives the toothed belt 25, the tension of which has been adjusted by the adjusting screws 18 and which drives in rotation the eccentric wheel 20, which produces an alternating translation movement of the blade 8 in its plane. The springs 28 maintain the blade 8 in tension between them so as to modify the natural frequency of the vibrating system, allowing to respond effectively to the behavior of the paste.

A cycle of spreading paste layer by scraping is now described with reference to FIGS. 1 to 6.

### FIG. 1

The scraping device is at rest. The scraping blade 8 is raised and stationary.

### FIG. 2

The scraping blade 8 is lowered and stopped when the desired layer height is correct.

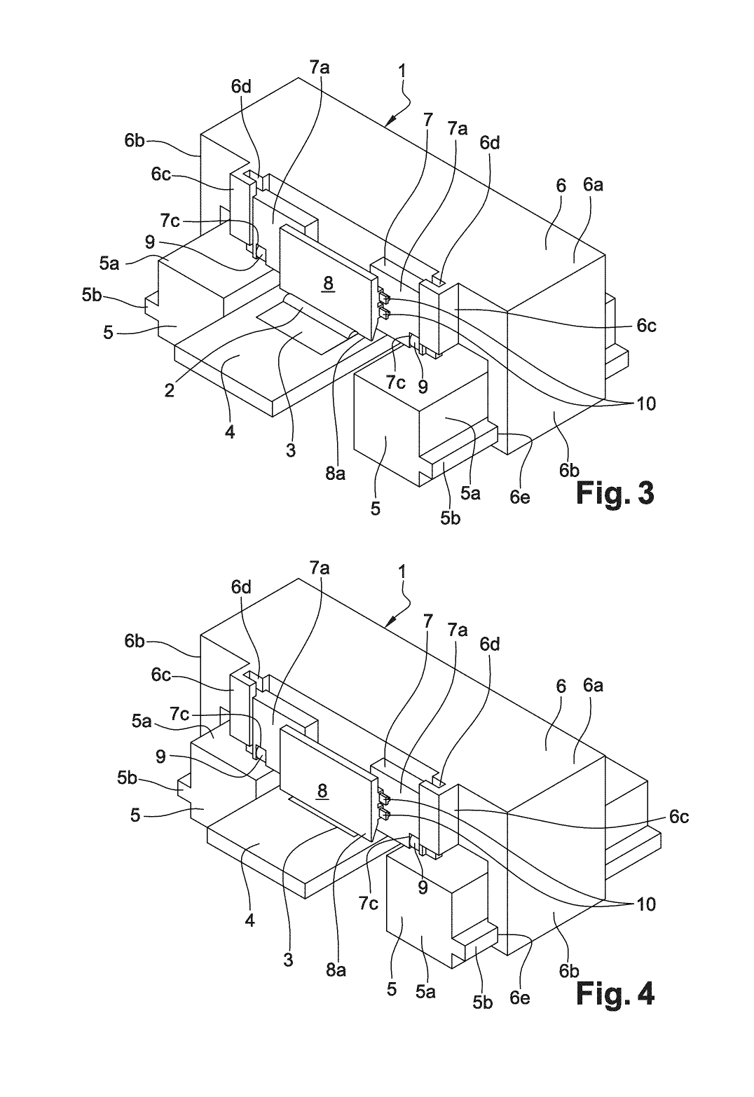

### FIG. 3

The paste is spread by advancing the scraping blade, which is during this advance subjected to the excitation for the vibration movement, as described above.

### FIG. 4

The scraping blade has almost reached the end of its stroke.

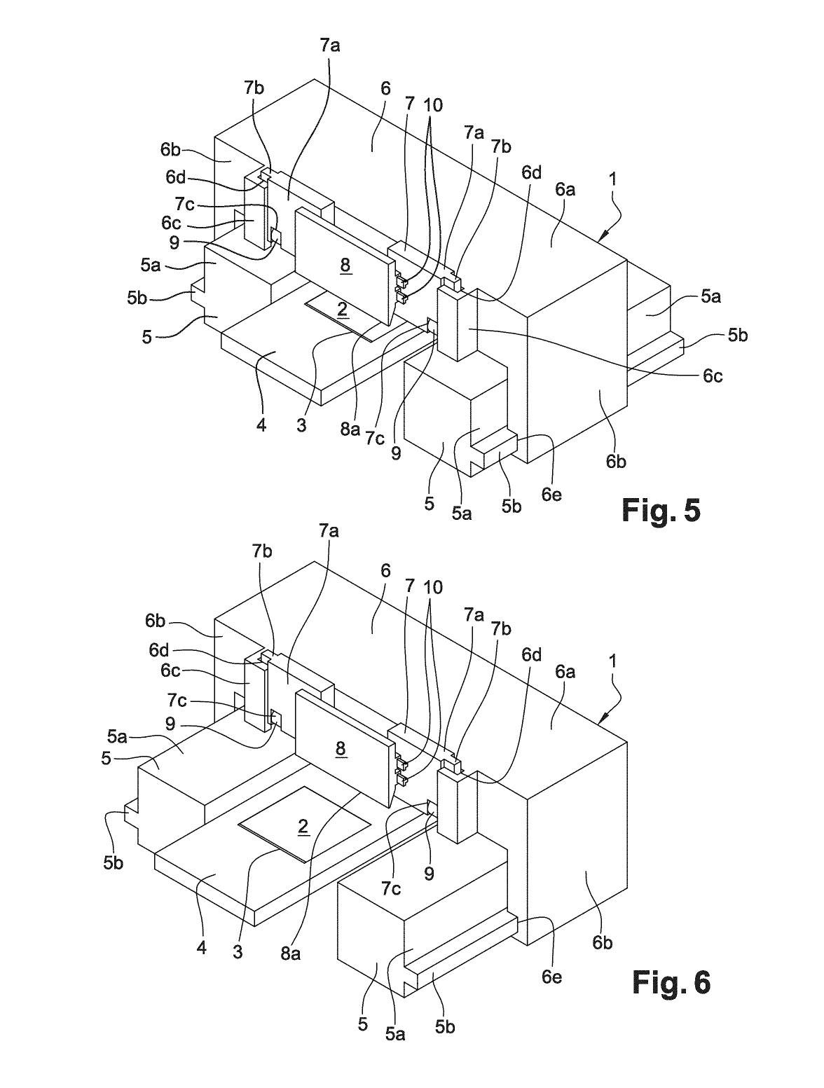

### FIG. 5

The scraping blade is then raised so as to be disengaged from the paste and it is returned to the rest position of FIG. 6.

We can see that the spread of the paste at each pass is effected in a perfectly homogeneous way, the piece as obtained having been proved as satisfactory.

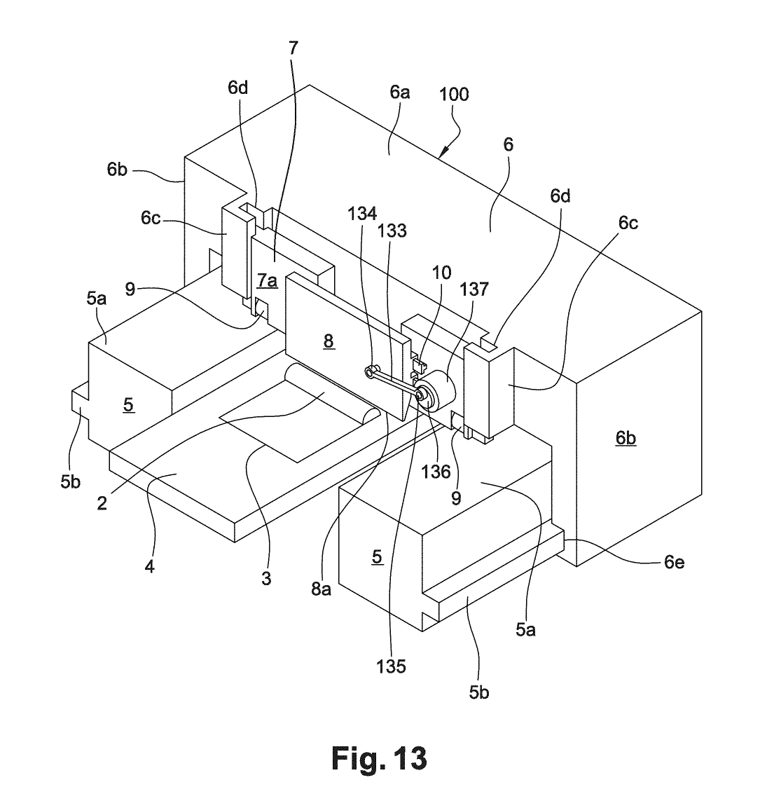

In reference to FIG. 13, another embodiment of the vibration mechanism of the blade 8 relative to the blade holder 7 has been schematically shown. A connecting rod 133 is attached to a position 134 on the blade 8 on one hand and on the other hand to an offset position 135 of a crank 136 driven in rotation by a motor 137 the axis of which is attached on the blade holder 7, on one side thereof (right side if we look at FIG. 13).

For starting the excitation for the vibration movement of the blade 8, the motor 137 is actuated that starts the connecting rod-crank system, which produces a back and forth translation movement of the blade 8 in its plane.

It can be noted that the vibration mechanism of FIGS. 7 and 13 could be replaced by a piezoelectric or electromagnetic driver housed in a housing to be mounted on the blade 8.

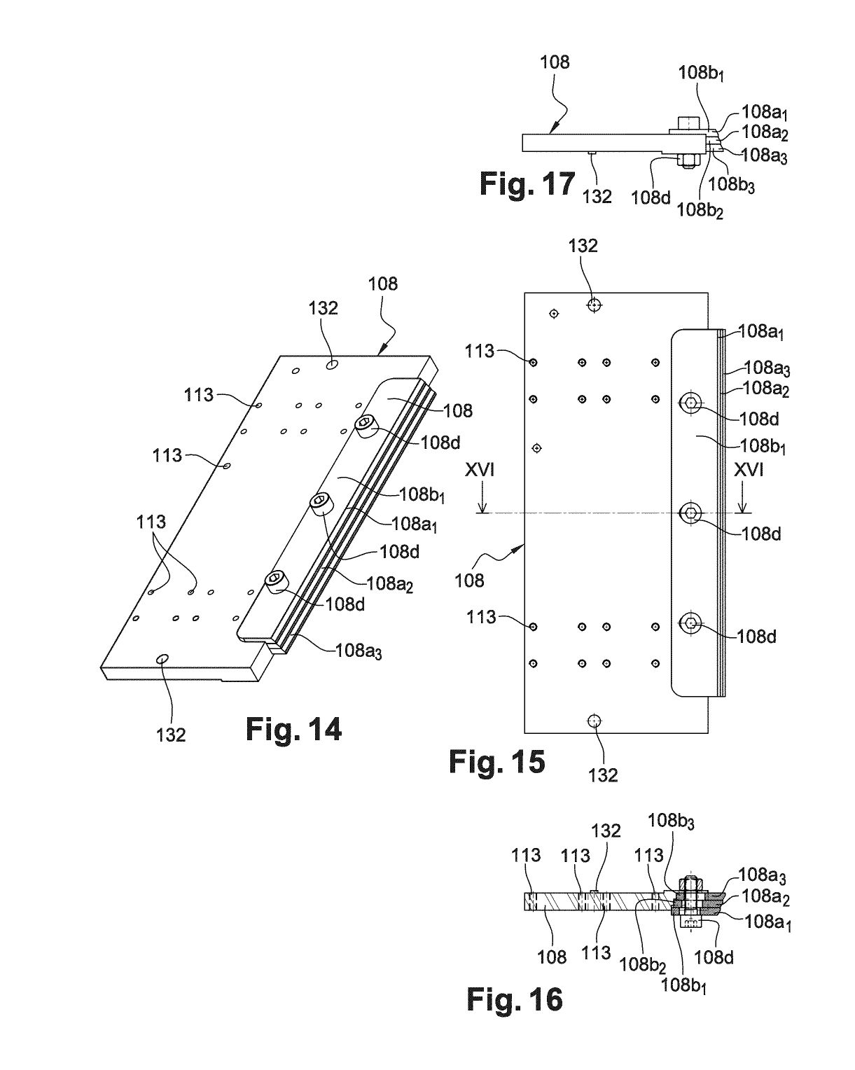

With reference to FIGS. 14 to 17, it has been shown a triple blade 108 which is an alternative embodiment of the blade 8 previously defined and the elements of which bear reference numerals higher by 100 to those of the respective elements of the blade 8. In fact, the lower thin strips are now three (108b₁, 108b₂ and 108b₃), applied against each other, bearing cutting edges 108a₁, 108a₂ and 108a₃ respectively, and arranged on the blade 108 at different heights so that the front edge 108a₁ enters less deeply in the paste mass to be spread than the following edge 108a₂, itself entering less deeply in the paste mass to be spread than the edge 108a₃.

It is then easier to spread the paste, because the force to be applied on each one of the blades during the scraping is less than in the case of only one blade.

The assembly of FIGS. 14 to 17 shows only an example of assembly: the lower thin strips could also be moved apart from each other or even the three blade edges could belong to three different blades and not to lower thin strips carried by only one blade.

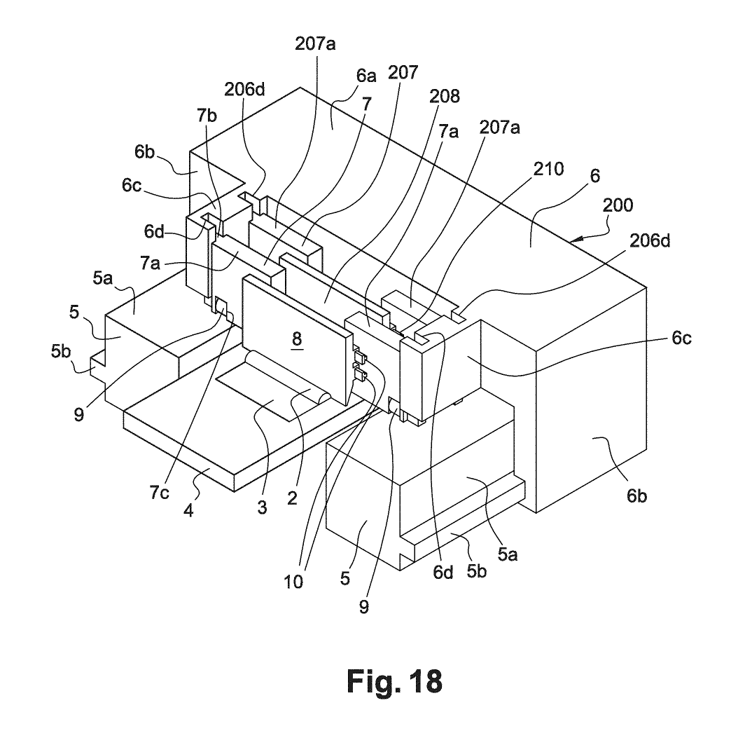

In reference to FIG. 18, it can be seen that a device 200 is shown which differs from the device 1 of FIGS. 1 to 6 by the fact that it comprises two scraping blades 8, 208 instead of one.

On FIG. 18, the same reference numerals refer to the elements common to those of the device 1 and only the differences will be described below.

Each protrusion 6c of the portal frame 6 is elongated in order to comprise a second groove 206d parallel to the groove 6d and located back to it in the example shown.

In these grooves 206d slides a second blade holder 207 identical to the blade holder 7, the side parts 207a of which adapted to slide in the grooves 206d can be seen.

The blade holder 207 can advantageously comprise wheels similar to the wheels 9 in order to roll on the frame 5.

The second scraping blade 208, the height of which is such that it will enter more deeply in the paste than the blade 8, is mounted on the side parts 207a of the blade holder 7 and is located between the side parts 7a and 207a. Like the blade 8, it comprises pads adapted to slide in the rails 210 of the blade holder 207.

The blade 208 is capable to go back and forth for the vibration movement under the action of the same driving means as those previously described; such means have not been shown on FIG. 18, as well as elastic return means similar to those of said blade 8. Thus, the excitation of the vibration movement of the two blades 8, 208 is adjustable in an independent manner.

The function of the device 200 is otherwise the same as that of the device 1, the two blades 8 and 208 advancing simultaneously in the pass advance motion while being subjected to the vibration movement.

1-22. (canceled)

23. A method for manufacturing a green piece made of ceramic material by the technique of additive manufacturing according to which layers of a photocurable paste are successively allowed to cure by irradiation according to a pattern defined for each layer, the first layer being formed on a working surface on a working tray, each layer, before curing according to a defined pattern, being spread by scraping a paste mass provided on the working tray which is lowered upon each formation of a layer, wherein, when spreading at least one of the photocurable paste layers, at least one scraping blade in working position, in addition to the scraping or so-called pass motion of at least one the scraping blade, is allowed to go back and forth in the plane of the at least one scraping blade, according to a so-called vibration motion, horizontal and perpendicular to the pass motion.

24. The method according to claim 23, wherein the pass motion results from having the at least one scraping blade (progressing according to a rectilinear horizontal displacement from an edge of the working surface along which was brought the paste mass to be spread in the form of a bead, to the opposite edge of the working surface, in order to spread the bead of paste on the working surface.

25. The method according to claim 23, wherein a pass motion results from sweeping the at least one scraping blade according to a pivoting movement about an axis perpendicular to the working surface and positioned in a point of the working surface.

26. The method according to claim 23, wherein the vibration frequency is determined according to the rheological characteristics of the paste, the frequency being chosen to reduce the viscosity of the paste.

27. The method according to claim 23, wherein at least one scraping blade is given a vibration movement by one of a mechanical driver system, a piezoelectric driver system and an electromagnetic driver system.

28. The method according to claim 27, wherein the vibration movement is done by a mechanical driver system at a frequency of 1 to 100 Hz.

29. The method according to claim 23, wherein the vibration movement is done on a stroke of 0.1 to 5 mm.

30. The method according to claim 23, wherein the at least one scraping blade is maintained in tension between two springs to modify the natural frequency of the vibration movement, allowing the at least one blade to vibrate at the resonance frequency of the oscillating system comprising the at least one blade, at least one associated blade holder and the springs.

31. The method according to claim 23, wherein the depth of penetration in paste of the scraping edge of at least one blade is adjusted.

32. The method according to claim 23, wherein the at least one scraping blade is one of a single scraping blade, at least two contiguous scraping blades parallel to each other, and at least two spaced scraping blades parallel to each other, the scraping edges of the blades being arranged at staggered heights, the scraping edge of the leading blade being the highest relative to the working surface, the vibration frequencies of the blades being possibly different.

33. The method according to claim 23, wherein:
(a) a paste mass to be spread is provided on a working tray, then a first layer of the paste is spread by scraping using the at least one scraping blade, along a horizontal direction, or pass direction;
(b) the desired area of the first layer is cured by irradiation according to a previously defined pattern for the first layer, forming a first cured layer in the desired area;
(c) a second paste layer is spread over the whole first cured layer in the desired area, by scraping using the at least one scraping blade, along the pass direction;
(d) the desired area of the second paste layer is cured by irradiation according to a previously defined pattern for the second layer, forming on the first layer a second cured layer in the desired area;
(e) the succession of steps of spreading a paste layer and of curing the desired areas of each layer is repeated as many times as required until obtaining the piece,
where, when spreading the at least one of the paste layers, the at least one scraping blade in working position is allowed to go back and forth according to a vibration movement in a horizontal direction perpendicular to the pass direction.

34. A machine for manufacturing green pieces made of ceramic material by the technique of additive manufacturing according to which layers of a photocurable paste are successively allowed to cure by irradiation according to a pattern defined for each layer, the machine comprising:
a frame surrounding a horizontal working tray comprising a working surface;
a portal frame equipped with at least one scraping blade, the portal frame being adapted to move on the frame over the working tray so that the free edge of the at least one scraping blade is adapted to spread by scraping paste layers over the working surface, the paste layers being vertically superimposed;
irradiation means facing the working tray to irradiate each layer once spread to cure the layer in the previously defined pattern before spreading the following layer, which is in turn cured in the defined pattern,
wherein the at least one blade is slidably mounted to go back and forth in the plane of the at least one scraping blade so as to ensure a back and forth movement, designated vibration movement, during at least a pass of the portal frame along the pass direction over the working surface.

35. The manufacturing machine according to claim 34, wherein the manufacturing machine comprises at least one blade holder, each blade holder holding at least one blade and being vertically movable on the portal frame, the at least one blade holder being adapted to be maintained and displaced in a top position, lifted up above the working tray.

36. The manufacturing machine according to claim 35, wherein the at least one blade holder comprises at least one horizontal rail and the at least one blade comprises at least one pad for the guiding of the at least one blade on the at least one rail.

37. The manufacturing machine according to claim 34, wherein the manufacturing machine comprises a device for driving the vibration movement of the at least one blade by one of a mechanical system, a piezoelectric system, and an electromagnetic system.

38. The manufacturing machine according to claim 37, wherein the driving device is an eccentric excitation mechanism and comprises an assembly constituted by a motor and a disc driven by the motor along an offset rotation axis, the offset rotation axis being in the pass direction.

39. The manufacturing machine according to claim 37, wherein the driving device is a mechanism comprising an assembly constituted by a motor, a crank and a connecting rod connected at one end to the front face of the at least one blade and at the other end to the crank driven by the motor on an offset rotation axis, the offset rotation axis being in the pass direction, the connecting rod being displaced in the plane of the at least one blade.

40. The manufacturing machine according to claim 37, wherein the driving device is a mechanism comprising an assembly constituted by a motor and a cam being in contact with a blade, the cam, driven by the motor on an offset rotation axis, rolling upon the rotation thereof by sliding against the at least one blade and causing the at least one blade to go back and forth.

41. The manufacturing machine according to claim 38, wherein the motor is controlled by the machine controller, being voltage controlled to ensure the searched frequency for the vibration movement.

42. The manufacturing machine according to claim 37, characterized in that the manufacturing machine comprises elastic return means of the at least one blade along a direction perpendicular to the pass direction.

43. The manufacturing machine according to claim 34, wherein the at least one blade is one of a single blade, at least two contiguous blades which are parallel to each other, and spaced blades which are parallel to each other.

44. The manufacturing machine according to claim 35, wherein the at least one blade holder comprises wheels allowing the at least one blade holder to roll over the frame.
